(19) United States
(12) Patent Application Publication
(10) Pub. No.: US 2008/0196214 A1
(43) Pub. Date: Aug. 21, 2008

(54) Rope Clip

(76) Inventor: Peter Eklund, Bergshamra (SE)

Correspondence Address: OSTROLENK FABER GERB & SOFFEN, 1180 AVENUE OF THE AMERICAS, NEW YORK, NY, 100368403, US

(21) Appl. No.: 11/917,819

(22) PCT Filed: May 18, 2006
(86) PCT No.: PCT/SE06/00574

§ 371 Date: Dec. 17, 2007

(30) Foreign Application Priority Data
Jun. 16, 2005 (SE) 0501373-5

(51) Int. Cl. F16G 11/14; F16G 11/10; F16G 11/04

(52) U.S. Cl. 24/132 R

(57) ABSTRACT

A rope clip for the interconnection of two parallel and adjacent rope parts, comprising two elongate elements, each of which has a concave elongate through channel that receives and substantially accommodates the cross section of a respective rope part. The two elements are mutually turnably connected to each other via a pivot joint in order to, in a turning end position, jointly, by the channels thereof, delimit an elongate throughput opening in which the two rope parts laterally are pressed against each other and against the respective channel surface, and a locking device is provided in order to interlock the elements in the turning end position thereof.

The invention relates to a rope clip for the interconnection of two parallel and adjacent rope parts, of the kind that is seen in the preamble of the appended independent claim 1.

With rope, an elongate flexible tensile force-transferring element is intended, such as a cord or the like.

The rope clip is primarily intended to enable quick and simple interconnection of two parallel and adjacent rope parts, which may constitute longitudinally spaced-apart portions of a rope bight, which then forms a loop. In that connection, a thimble may be inserted in the loop.

An object of the invention is to provide a rope clip that readily and securely enables connection of the rope parts to each other. A special object is, in that connection, to form a rope loop, possibly with a thimble inserted in the loop.

An additional object is to provide a rope clip that upon closure offers a leverage for the generation of a high local mutual pressing pressure for the rope parts against each other and against adjacent surfaces of the rope clip.

An additional object is to provide a rope clip that may be produced from two mutually substantially equal rope-clip elements.

The objects are attained by a rope clip according to the invention.

The invention is defined in the appended independent claim 1. Embodiments of the invention are defined in the appended dependent claims.

In the following, the invention will be described by way of examples, reference being made to the appended drawing.

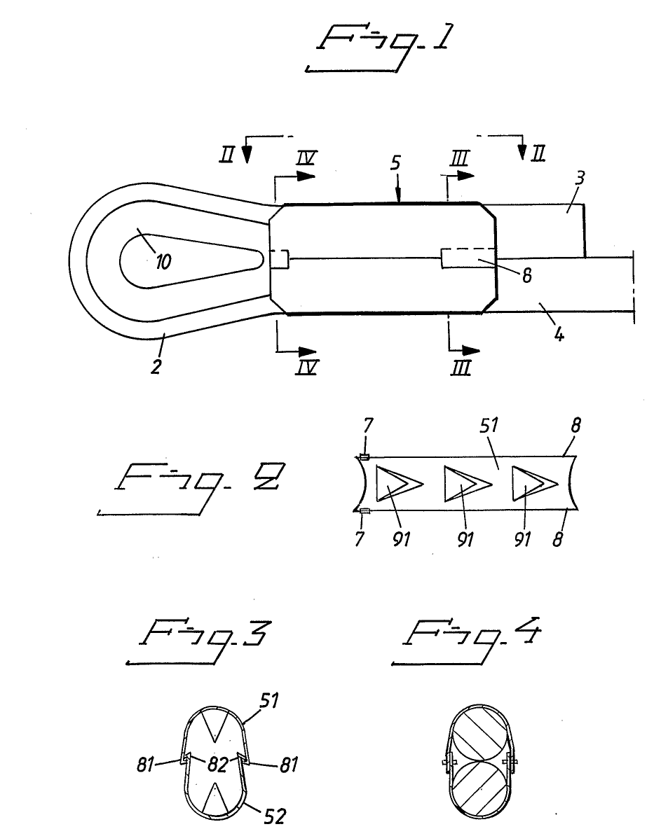

FIG. 1 shows a rope clip as applied to a rope bight.

FIG. 2 shows a view of the rope clip, taken along line II-II in FIG. 1.

FIG. 3 shows a schematic section taken along line III-III in FIG. 1.

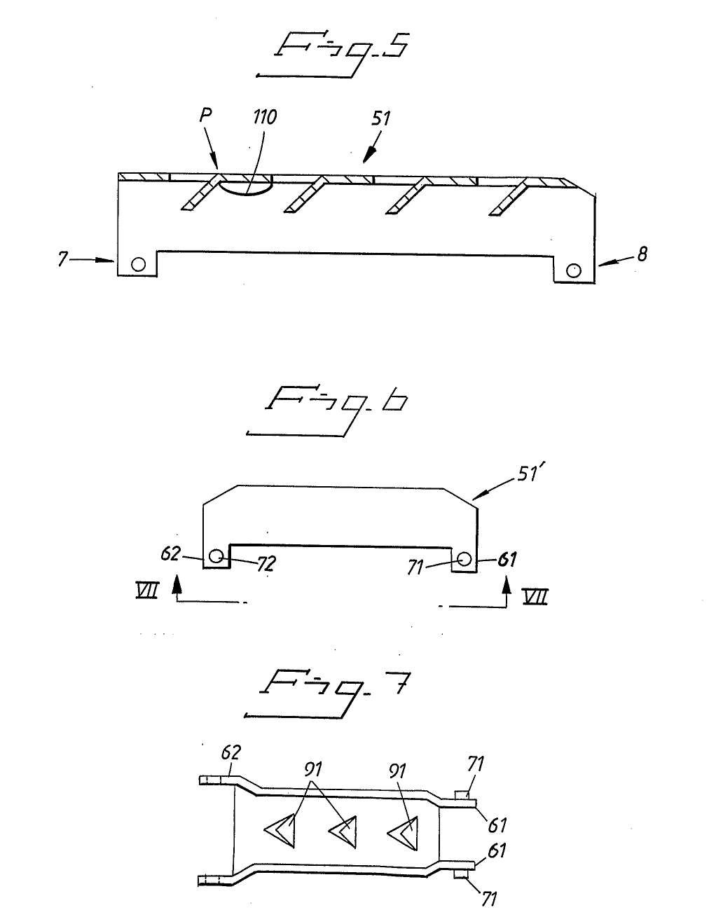

FIG. 4 illustrates a schematic section taken along line IV-IV in FIG. 1.

FIG. 5 shows a variant of a rope-clip element for a rope clip according to the invention.

FIG. 6 shows a side view of another rope-clip element.

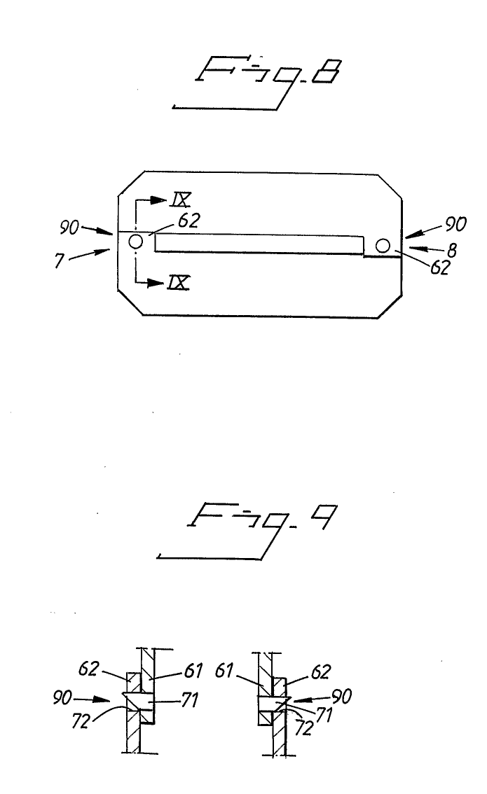

FIG. 7 shows a view taken along line VII-VII in FIG. 6.

FIG. 8 shows a rope clip that is produced from two elements according to FIGS. 6 and 7.

FIG. 9 schematically shows a section taken along line IX-IX in FIG. 8.

FIG. 1 illustrates a rope 1 having an end portion that is formed into a bight having parallel and adjacent rope parts 3, 4, which are interconnected with a rope clip 5 for the formation of a rope loop 2, which possibly may be carried by a thimble 10. The rope clip 5 is shown comprising two preformed pipe-shaped elements 51, 52, which are situated opposite each other and have the concave sides thereof facing each other, the branch ends of the preformed pipes being shown to be adjacent to each other and shown connected to each other by means of a pivot joint 7 and a locking device 8, which bridge over nearby branch portions on each side of the clip device 5. The pivot joint may be formed by a through shaft shank that extends through aligned pairs of overlapping mounting holes in the two pairs of overlapping element branches. Alternatively, the pivot joint may be formed by separate pivot mountings at the respective pair of overlapping element branches, the pivot mountings being aligned against each other along an axis that is perpendicular to the element branches and the longitudinal symmetry plane of the elements.

In FIG. 1, it can be seen that the end part of the rope clip 5 that is facing the loop 2 is provided with the pivot mounting 7, so that the elements 51, 52 always form a closed pipe trench in the area of the pivot mounting. Furthermore, the ends of the bottom web of the elements 51, 52 are situated at a distance from the pivot mountings, toward the locking device 8. In this way, the effect is attained that the free throughput area at the pivot mounting 7 increases, when the elements 51, 52 are turned apart from each other around the pivot mounting, whereby the threading-through of the two rope parts 3, 4 through the rope clip in the area of the pivot mounting is facilitated, and whereby a squeeze effect is attained when the elements 51, 52 are turned toward each other for the establishment of the locking 8. The locking device 8 guarantees an interlocking of the elements 51, 52 when the same extend substantially parallel to each other.

The locking device 8 is shown at the opposite end of the rope clip 5 in relation to the pivot mountings 7. In the closed state of the rope clip 5 shown in FIG. 1, the two rope parts 3, 4 experience a mutual compression and a pressing against the concave sides of the elements 51, 52. In the bottom portion thereof, each of the elements 51, 52 has radially inward projecting protuberances that, for instance, may be in the form of triangular tongues 91, which are punched/cut out from the bottom portion of the respective element 51, 52 and folded-in toward the central part of the rope clip 5. The protuberances 91 serve to enhance the local contact pressure against the nearby the areas of the rope parts 3, 4 in order to decrease the risk that the same should slide axially in relation to the rope clip 5. When the protuberances 91 consist of tongues or prickles, the same can stick into the rope parts 3, 4 and offer a blocking in respect of the sliding of the rope parts 3, 4 in relation to the respective element 51, 52.

When a thimble 10 is inserted into the loop 2, the size of the loop and the correct insertion of the rope loop into the circumferential groove (not shown) in the thimble may readily be adjusted when the rope parts 3, 4 extend through the rope clip, but before the elements 51, 52 of the rope clip have been turned into locking engagement of the locking devices 8.

The locking devices 8 may, as mentioned, be composed of undercut surface portions 81, 82, which are arranged on the adjacent profile branch sides of the elements 51, 52 and can snap into each other. Alternatively, the locking device 8 could be composed of a locking pin that extends through the rope clip between the rope parts 3, 4 via openings in overlapping adjacent verge portions of the elements 51, 52 on each side of the rope clip, wherein the locking pin could be secured by a lock nut.

FIG. 8 illustrates a side view of another embodiment of a rope clip according to the invention, which is constructed from two mutually equal rope-clip elements 51′ according to FIGS. 6 and 7. Once again, the web of the element 51′ has punched and bent-in teeth 91. At each axial end of the element 51′, there is a projecting tongue 61 and 62, respectively, on each branch. The tongues 61 at one end of the element have a somewhat smaller mutual distance than the tongues 62 at the other end of the element, in order to allow the tongues to be brought more easily into overlapping upon the bringing together of the elements 51′ for the formation of the rope clip according to FIG. 8. As is seen in FIG. 7, the tongues 61 have projecting shaft journals 71, which are obliquely chamfered. The tongues 62 have openings/borings 72 in order to receive the journals 71, when the two elements 51′ have been brought into overlapping by tongues 61, 71. The journals 71 have the greatest projection thereof from the tongue's 61 external surface in the area closest to the web of the element, and have the smallest projection thereof at a position diametrically opposite the greatest projection, the smallest projection preferably being situated at the external surface of the tongue 61.

First, the journals 71 and the holes 72 of the elements at one of the rope clip ends are brought together, for the formation of a pivot mounting 7, before the closure of the rope clip. Subsequently, when the rope-clip elements 51′ mutually are turned toward each other around the pivot mounting 7, a snap-locking effect is offered when the remaining journals 71 snap into the appurtenant openings 72 thereof and form the lock 8.

FIG. 5 illustrates an embodiment in which at least one of the rope-clip elements 51, near the pivot mounting 7 thereof, has an inner limitation of the depth of the U-section. In FIG. 5, it is shown that a filling body 110 has been placed on the inside of the web of the element in order to limit the free depth thereof locally. The body 110 creates a more powerful mutual compression of the rope parts against each other and against adjacent surface portions of the rope elements, at a position P, corresponding to the situation of the body 110, the distance between the pivot joint and the position P being much smaller than the distance between the locking 8 at the other end of the element 51 and the position P of the filling 110. In this way, a leverage is created that makes it possible to manually apply a local high pressure to the rope parts in the rope clip by means of the filling body 110 inserted.

As an alternative to the filling body 110, the web 51 of the element may be provided with a dent, which offers the same effect as the filling 110. As another further alternative, the web of the element 51 may be generally curved in order to produce a maximum pressing force at the position P.

The filling 110 may be mounted in only one of the rope-clip elements 51, but may naturally also be placed in each one of the two elements of the rope clip, but, in doing so, preferably in such a way that both of them lie closer to the pivot joint 7 than the clip 8.

The pivot joint 7 as well as the lock 8 may be in the shape of a snap-locking device 90 having pivot-joint function. Further, in FIG. 7, it can be seen that the journal 71 may be composed of a shaft piece that is fixed in a corresponding boring in the tongue 61. However, the counterpart to the projecting chamfered end portion of the journal may be created by the fact that a tab having circular contour partially is punched out from the respective tongue 61 and bent-out obliquely therefrom, so that the outside thereof offers the counterpart to the outer oblique chamfered surface of the journal 71.

1. A rope clip for the interconnection of two parallel and adjacent rope parts, comprising two elements, each of which has a concave channel, which together accommodate the cross section of the two rope parts, the two elements being mutually turnably connected to each other by a pivot joint in order to, in a first turning end position, jointly, by the channels thereof, delimit a throughput opening in which the two rope parts laterally are pressed against the channels, a locking device being provided in order to interlock the elements in said turning end position thereof, and the two elements having teeth that in said turning end position of the elements engage the rope parts wherein the two channels each substantially accommodates the cross section of a respective rope part, and that the pivot joint and the locking device are arranged at opposite ends of the channel ends of the elements.

2. The rope clip according to claim 1, wherein the locking device comprises two undercut co-operating formations on the nearby branch ends of the elements.

3. The rope clip according to claim 1 wherein each element has a U-shaped cross section in an area between the ends thereof and that the pivot joint is situated outside a nearby end of the bottom web of the U-line shaped elements, whereby the throughput opening of the rope clip near the pivot mounting widens when the elements are turned apart from each other.

4. The rope clip according to claim 1, wherein the teeth are placed on the bottom web of the elements.

5. The rope clip according to claim 4, wherein the teeth are formed of protuberances punched in the bottom web of the elements, which protuberances are bent-in in the respective channel.

6. The rope clip according to claim 1, wherein at least one of the elements on the inside of the bottom web thereof has a formation, which locally limits the free cross section through the closed rope clip, the formation preferably being situated closer to the pivot joint than the locking device.

7. The rope clip according to claim 6, wherein the formation is formed of a spacing body that is mounted on the bottom web or of an integrated part of the bottom web.

8. The rope clip according to claim 2, wherein each element has a U-shaped cross section in an area between the ends thereof and that the pivot joint is situated outside a nearby end of the bottom web of the U-line shaped elements, whereby the throughput opening of the rope clip near the pivot mounting widens when the elements are turned apart from each other.

9. The rope clip according to claim 2, wherein the teeth are placed on the bottom web of the elements.

10. The rope clip according to claim 3, wherein the teeth are placed on the bottom web of the elements.

11. The rope clip according to claim 2, wherein at least one of the elements on the inside of the bottom web thereof has a formation, which locally limits the free cross section through the closed rope clip, the formation preferably being situated closer to the pivot joint than the locking device.

12. The rope clip according to claim 3, wherein at least one of the elements on the inside of the bottom web thereof has a formation, which locally limits the free cross section through the closed rope clip, the formation preferably being situated closer to the pivot joint than the locking device.

13. The rope clip according to claim 4, wherein at least one of the elements on the inside of the bottom web thereof has a formation, which locally limits the free cross section through the closed rope clip, the formation preferably being situated closer to the pivot joint than the locking device.

14. The rope clip according to claim 5, wherein at least one of the elements on the inside of the bottom web thereof has a formation, which locally limits the free cross section through the closed rope clip, the formation preferably being situated closer to the pivot joint than the locking device.
